(19) United States
(12) Patent Application Publication
(10) Pub. No.: US 2025/0052894 A1
(43) Pub. Date: Feb. 13, 2025

(54) AI-GENERATED ALGORITHMS FOR PROCESSING SYNTHETIC APERTURE RADAR DATA

(71) Applicant: Gtwerx AI, Inc., Ann Arbor, MI (US)

(72) Inventors: Ryan Michael Farris, Fairfax, VA (US); Clyde Michael Stanfield, Brighton, MI (US); Reuben Merrell Sorensen, Ann Arbor, MI (US)

(21) Appl. No.: 18/796,042

(22) Filed: Aug. 6, 2024

Related U.S. Application Data
(60) Provisional application No. 63/518,303, filed on Aug. 8, 2023.

(51) Int. Cl. G01S 13/90; G06F 40/40

(52) U.S. Cl. CPC G01S 13/9021; G06F 40/40

(57) ABSTRACT

Technology is disclosed herein for systems and methods of SAR data processing based on generative AI models. In an implementation, a computing apparatus receives a request for information based on synthetic aperture radar data. The computing apparatus generates a prompt for a generative artificial intelligence (AI) model based on the request, wherein the prompt includes a request for processing instructions. The computing apparatus receives the processing instructions and generates a processing algorithm based on the processing instructions. The computing apparatus executes the processing algorithm on SAR data to generate a result responsive to the request.

### CROSS REFERENCE TO RELATED APPLICATIONS

This application is related to U.S. Provisional Patent Application entitled “AI-GENERATED ALGORITHMS FOR PROCESSING SYNTHETIC APERTURE RADAR DATA,” Application No. 63/518,303, filed on 8 Aug. 2023, the contents of which is incorporated by reference in its entirety for all purposes.

### TECHNICAL FIELD

This relates generally to processing of radar data from satellite or airborne platforms, and more particularly, to automated generation of algorithms for processing radar data from a satellite or airborne platform.

### BACKGROUND

As urbanization and industrialization continue to alter landscapes around the world, satellite imaging becomes increasingly important to produce high-resolution, detailed images of three-dimensional structures and topography quickly and reliably. Challenges to satellite imaging technology, such as electro-optical imaging techniques, include cloud cover and other atmospheric conditions which can obscure areas of interest or add noise or distortion to the images. Satellite imaging via high-resolution synthetic aperture radar (SAR) captures images irrespective of weather or sunlight. The downside of SAR technology is that processing SAR data for consumption is a complex process, and the processing workflows may be narrowly tailored for specific purposes. Further, processing SAR data relies on specialized expertise the mastery of which can take years of training and experience, which further limits resources for processor development.

In particular, SAR data is known for its dense, raw data which requires long and expensive processing times. In some cases, SAR processing can take hours or days to convert raw data into a consumable product. The problem will become more acute as more commercial SAR satellites are launched. Indeed, the data volume and pace of SAR data is expected to increase significantly but with the continuing challenge of providing downstream data consumers with timely access to this rich dataset.

Moreover, SAR processors are often designed for specific sensor hardware and often include proprietary technology. When new sensors are introduced or when new tasks are identified for existing sensors, adapting existing processors or developing new processing algorithms can take months or even years of Ph.D. level scientists and engineers. Thus, the delay between data collection and producing actionable information can be a significant impediment to real-time adaptative processing for emergent situations. And as the commercial space sector continues to launch new SAR satellites with improved resolution and increased revisit rates, users may not have access to critical intelligence information in a timely manner, which can put them at a disadvantage in the field.

### SUMMARY

Disclosed herein are systems, methods, and devices for processing SAR data, and more particularly, to automated generation of processing algorithms for processing SAR data. In an implementation, a computing apparatus receives a request for information based on synthetic aperture radar data. The computing apparatus generates a prompt for a generative artificial intelligence (AI) model based on the request, wherein the prompt includes a request for processing instructions. The computing apparatus receives the processing instructions and generates a processing algorithm based on the processing instructions. The computing apparatus executes the processing algorithm on SAR data to generate a result responsive to the request.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operational environment for SAR data processing in an implementation.

FIG. 2 illustrates a method for SAR processing in an implementation.

FIG. 3 illustrates an operational environment for SAR data processing in an implementation.

FIGS. 4A and 4B illustrate examples of prompts for a generative AI model for SAR processing.

FIG. 5 illustrates a computing device that may be used in accordance with some examples of the present technology.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

Technology is disclosed herein for systems and methods for processing synthetic aperture radar (SAR) data using generative AI. In an implementation, an end-to-end processing platform includes a generative AI model, such as a fine-tuned large language model (LLM), and other computational engines to perform a number of tasks: generate processing instructions responsive a user's natural language query, select SAR datasets for processing, generate data processing algorithms based on the processing instructions, optimize the algorithms for accelerated compute hardware such as GPUs or distributed cloud computing, and execute the processing algorithms on the selected datasets to generate a response to the query. By automating the process of generating tailored algorithms, the tailored algorithms can be rapidly deployed with substantially reduced coding time and SAR data processing expense.

In an implementation, a user enters a natural language query in a platform interface for information to be extracted, determined, or identified from SAR data. The query requests information from existing (e.g., recently captured) SAR data. The query may include a region or location (e.g., a sector of military operations specified in GPS coordinates), a time frame (e.g., the preceding half-hour or week), and the type of information that is sought (e.g., images of a spy balloon in flight over an area of interest).

Upon receiving the query, a prompt engine of the platform generates a prompt for an LLM which tasks the LLM with generating instructions for processing selected SAR data to generate a response to the user's query or to perform the task identified in the query (e.g., identify balloons in SAR data captured for the specified location during the specified interval). The LLM receiving the prompt is trained using a set of existing SAR data processing algorithms paired with natural language queries representative of what a user might ask to initiate development of the algorithms. Based on its training, the LLM generates instructions responsive to the query and returns a reply including the instructions to the processing platform. The reply may include instructions for selecting SAR data or SAR datasets and for processing the datasets to generate information responsive to the query.

Based on the processing instructions received from the LLM, the processing platform uses a natural language processor to parse the instructions and generate processing algorithms. In various implementations, the natural language processor may be a deterministic natural language processing engine or a generative AI model, such as a second LLM. The instructions are then translated or converted by the natural language processor into one or more processing algorithms which will be applied to the SAR data or datasets that were specified in the instructions. The processing platform executes the algorithms generated by the LLM to process the selected SAR data and post-processes the output to analyze the output and generate a briefing supplying the requested information in a convenient format to the user. For example, a generative AI model for image analysis may be used to identify objects (e.g., balloons) in an output image of the processing algorithm. Alternatively, a multimodal foundation model may be tasked with generating a text description of an output image responsive to the user's query.

The SAR data selected for processing by the LLM may include data acquired according to the location and time information specified in the query and which has been pre-processed for subsequent processing according to the generated algorithms. The pre-processing may include standardizing SAR data from multiple sources so that the generated algorithms can be applied to the SAR data without having to modify or adapt the algorithms for specific datasets.

Because SAR data may be sourced from any number of different sensors, satellites, or other airborne sources, the datasets that are available for processing may vary in the type of data captured, the method by which the data was captured, and the format of the data. For example, SAR data may be classified according to characteristics such as polarization type (single, dual, quad, etc.); multichannel or multifrequency interferometry or polarization; beam, spotlight, or strip map; image resolution; and so on. In various implementations, the processing platform includes a data pre-processor engine which strips away metadata from the datasets and reformats the data into a common data format, creating standardized SAR datasets available for selection and processing. With the SAR data in a common format, the processor can be used to process the data. In various implementations, the processor is sensor-agnostic, meaning it can process SAR data regardless of the source.

The sensor-agnostic processor of the processing platform employs a library of modules and primitives for its neural network architecture. Upon receiving a processing algorithm from the natural language processor, the processor configures its neural network architecture according to the modules and primitives as indicated in the processing instructions. The processor requests and obtains SAR data or datasets for processing from a datastore of standardized SAR data. The datastore may include databases which store the standardized SAR data according to the satellite or aircraft, sensor, collection timeframe, imaged location, and so on. The processor then executes the processing algorithm on the SAR data, generating output for responding to the user's query. The processing platform may also post-process the generated output to render the output in a usable format for the user.

In some scenarios, a single LLM may generate the processing algorithms directly based on the user's natural language query. For example, in response to receiving the query, the platform initiates processing of the SAR data based on the query by producing processor algorithms using generative AI which are tailored for the particular task.

Technical effects of the technology enclosed herein include not only the ability to generate useful information from SAR data more quickly but also to more fully leverage the data that is available. Traditional SAR processing focuses on creating very specialized products for narrowly focused intelligence missions. These products have been built up over the years and utilize standard image products as inputs. But because these input have been built for human interpretation and not algorithm consumption, a substantial amount of data is often thrown away as unusable. The systems, methods, and techniques described herein leverage generative AI to create custom algorithms which can more fully leverage the raw data.

Another technical effect of the disclosed technology is the ability to adapt to different sensors (onboard satellite or aircraft technology to capture SAR data, such as a synthetic aperture radar) in real-time. Sensors often display anomalies over time that can degrade performance, and overcoming these anomalies requires highly specialized algorithm tuning. However, as disclosed herein, these tuning operations can be automated, and the platform can find optimal per-collect tuning parameters and create these algorithms from scratch, if necessary. The technology disclosed herein may also eliminate the need for sensor and satellite or airborne sensor providers to develop expensive, specialized processing solutions to meet military applications, among other applications. The platform's sensor-agnostic SAR processor may also allow for seamless integration with all commercial and government SAR providers.

The ability to process SAR data quickly and efficiently is essential for tactical, time-sensitive missions. The disclosed platform includes a 30-second processing timeline requirement for all products, achieved through a distributed GPU or CPU processing framework. The distributed framework can be applied on any commercial or government cloud processing solution. Additionally, as data sizes grow, additional GPUs or CPUs can be added to the cluster to reduce overall processing timelines.

In addition, the technology enables any user, regardless of their training or skill set, to process and consume SAR data more quickly and easily than using traditional, labor-intensive methods. For SAR consumers, the platform can provide on-the-fly unique algorithms to process their specific problem. In addition, a generative AI chatbot feature can be included to allow users to ingest SAR data without requiring highly specialized SAR knowledge to interpret pixels. The platform may also offer a secure web-based platform to make all the features accessible to any user with an active internet connection.

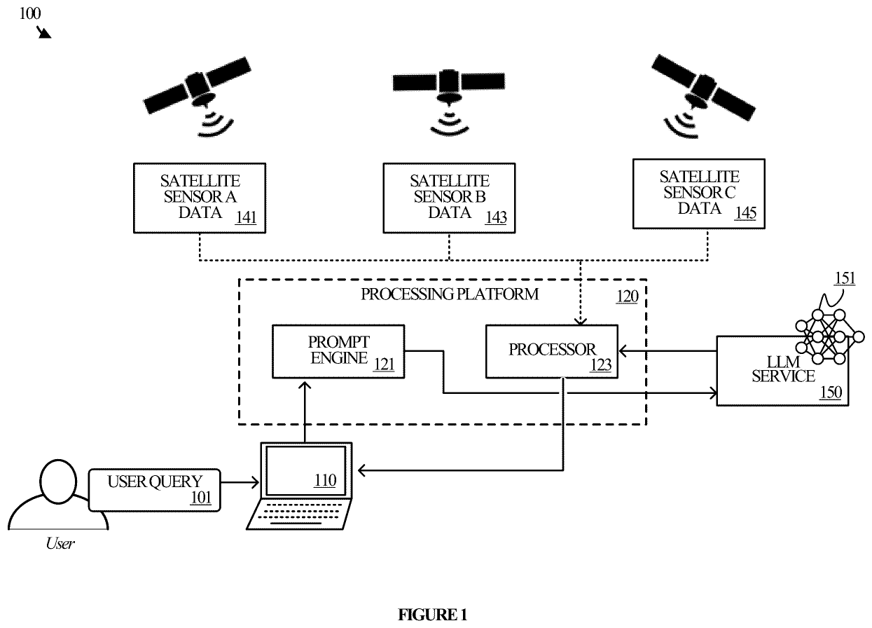

Turning now to the figures, FIG. 1 illustrates operational environment 100 for processing SAR data using AI-generated processing algorithms in an implementation. Operational environment 100 includes computing device 110 receiving user query 101, processing platform 120 including prompt engine 121 and processor 123, SAR data 141, 143, and 145, and LLM service 150 hosting LLM 151. (It may be appreciated that processor 123 is representative of a processing system including one or more processors which execute SAR data processing algorithms generated according to the processing instructions.) SAR data 141, 143, and 145 are received by processor 123 from one or more of multiple satellites and/or satellite SAR devices. SAR data 141, 143, and 145 may vary in terms of subject matter (e.g., when the images were captured and the location captured), image characteristics, data format, and so on.

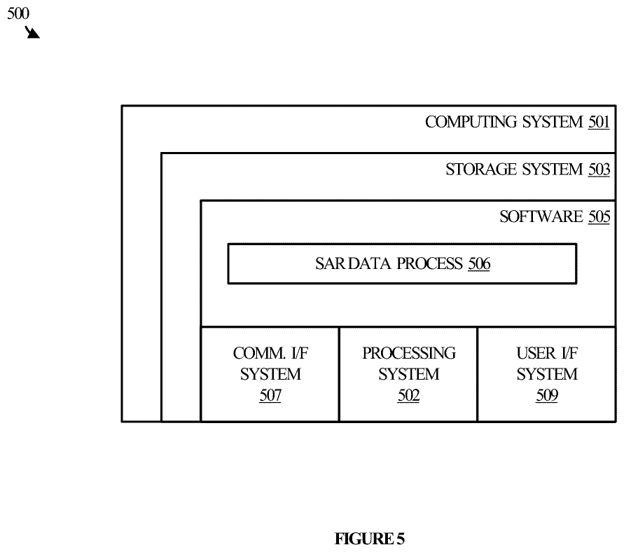

Processing platform 120 is representative of one or more computing services capable of interfacing with computing device 110. Processing platform 120 may be implemented in software in the context of one or more server computers co-located or distributed across one or more data centers. Examples of such servers include web servers, application servers, virtual or physical servers, or any combination or variation thereof, of which computing device 501 in FIG. 5 is broadly representative. Processing platform 120 may communicate with computing device 110 via one or more internets, intranets, the Internet, wired and wireless networks, LANs, WANs, and any other type of network or combination thereof.

LLM service 150 is representative of one or more computing services capable of hosting a foundation model or LLM computing architecture and communicating with processing platform 120. LLM service 150 may be implemented in the context of one or more server computers co-located or distributed across one or more data centers. LLM service 150 hosts LLM 151 which is representative of a deep learning AI model, such as GPT-3®, GPT-3.5, ChatGPT®, or GPT-4, BERT, ERNIE, T5, XLNet, or other foundation model. LLM service 150 interfaces with prompt engine 121 to receive prompts associated with user query 101 and to return replies including SAR data processing instructions or algorithms to processor 123.

Computing device 110 is representative of computing devices, such as laptops or desktop computers, mobile computing devices, such as tablet computers or cellular phones, and any other suitable devices of which computing device 501 in FIG. 5 is broadly representative. Computing device 110 communicates with processing platform 120 via one or more internets and intranets, the Internet, wired or wireless networks, local area networks (LANs), wide area networks (WANs), and any other type of network or combination thereof. A user interacting with computing device 110 submits user query 101 for submission to processing platform 120 via a user interface of processing platform 120 displayed on computing device 110, such as a chatbot interface.

In a brief example of the technology disclosed herein, a user submits user query 101 via computing device 110 to prompt engine 121 of processing platform 120. Prompt engine 121 configures a prompt based on user query 101 and submits the prompt to LLM service 150. The prompt tasks LLM service 150 with generating instructions for processing SAR data 141, 143, and/or 145 to generate information responsive to user query 101.

Upon receiving the prompt, LLM 151 generates processing instructions based on the prompt, and LLM service 150 returns a reply including the instructions to processor 123 of processing platform 120. Processor 123 selects SAR data from among SAR data 141, 143, and 145 for processing based on the instructions and configures a processing algorithm according to the instructions. To configure the processing algorithm, a natural language processor (not shown) of processing platform 120 parses the output from the LLM and identifies modules and primitives which are to be used by a SAR data processor to process the SAR data. Processor 123 configures the modules and executes the processing algorithm to process the selected SAR data to generate output responsive to user query 101. Processor 123 transmits the generated output to computing device 110.

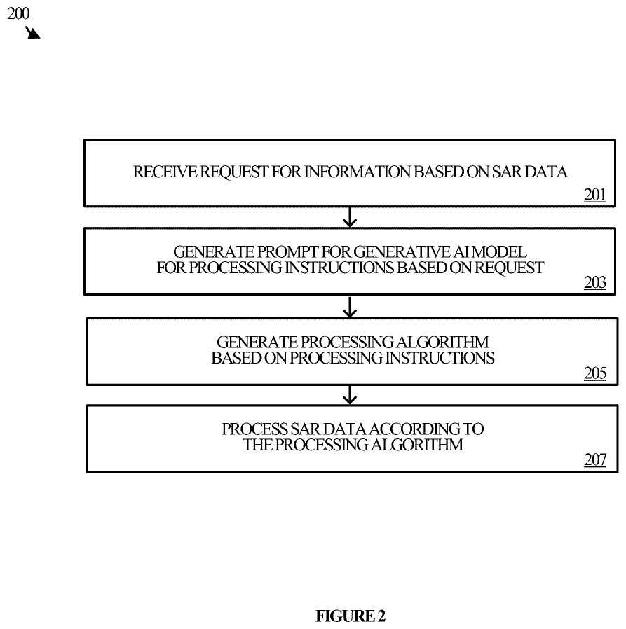

FIG. 2 illustrates process 200 for processing SAR data in an implementation. Process 200 may be implemented in program instructions in the context of software applications, modules, components, or other elements of one or more suitable computing devices, of which computing device 501 of FIG. 5 is representative. The program instructions direct the computing device(s) to operate as follows, referring parenthetically to the steps of FIG. 2 and in the singular for the sake of clarity.

A processing platform receives a request from a user computing device for information from SAR data (step 201). In an implementation, the user computing device is in communication with a SAR data processing platform, such as a cloud-based service, executing remotely from the computing device. A user enters a natural language query for information which is to be derived from SAR data. The query may indicate a particular geographic location or area and a timeframe of the data collection. The query may be a text input entered into the computing device via a user interface hosted by a processing platform.

The processing platform generates a prompt for a generative AI model based on query (step 203). In an implementation, a prompt engine of the processing platform generates the prompt based on a prompt template identified according to information received from the user, such as a particular SAR data type or dataset, the type of information requested, and so on. The prompt template may include rules or instructions which task the LLM with generating its output in a particular manner. For example, the prompt template may indicate the operations that are available for processing the SAR data, such as the contents of a library of modules and primitives for a processing architecture. The prompt template may specify which datasets are available for processing along with a scope or parameters of the data collection for the datasets. The prompt template may also specify a parse-able format for the output from the LLM. The prompt engine includes the natural language query in the prompt and submits the prompt to the LLM.

Upon receiving the prompt, the LLM generates processing instructions for processing the SAR data. In various implementations, the LLM is previously trained or fine-tuned to generate SAR data processing instructions using a training dataset of natural language queries and processing algorithms as well as other information relating to SAR data processing, such as data formats, image characteristics data, and so on. The processing instructions generated by the LLM may include data processing operations specific to the user query, the source satellite or SAR sensor, and the available SAR datasets. The LLM then generates the processing instructions, including indicating the SAR data or datasets to be processed according to the instructions, and returns output including the processing instructions to the processing platform.

When the processing platform receives the processing instructions, a natural language processor of the processing platform parses the output to extract the instructions. In an implementation, the natural language processor is trained to parse the output and generate procedural code for processing the SAR data. To generate the processing algorithm, the trained natural language processor tokenizes the output by breaking down the text of the output into smaller units (tokens), which can include words, phrases, or characters. The natural language processor then assigns grammatical tags to the tokens to indicate the syntactic category of the token (e.g., noun, verb, adjective) and uses the roles of the tokens in their respective sentences or phrases to determine a grammatical structure of the text. In addition, the natural language processor identifies named entities in the text, such as locations, dates or timeframes, particular datasets, and so on, which add contextual information to the text for parsing. To parse the output, the natural language processor analyzes the grammatical structure of the text to understand relationships between the words or tokens, such as subject-verb relationships or noun phrases. Based on the parsed output, the natural language processor generates an algorithm for processing the SAR data.

To generate the algorithm, in an implementation, the natural language processor configures radar data processing operations such as change detection, subaperture processing, automatic target recognition (ATR), and moving target indicator (MTI) processing. Other, basic processing operations which may be configured to use include FFT, phase ramp, multiply, convolution, pooling, conjugate, and the like. The processor of the processing platform then executes the algorithm to process SAR data (step 207). When executing the algorithm, the processor interfaces with one or more databases to obtain the SAR data or datasets selected by the LLM for processing. The algorithm causes the processor to execute the various data processing operations indicated in the processing instructions on the selected SAR data to generate processed data. Subsequent to generating the processed data, in some implementations, the processor may perform post-processing operations to highlight the information most relevant to the user query and to format the information in a more useful form. The processed data or information derived from the processed data is then sent to the interface on the user computing device where the user may view, download, print, or export the processed data or information.

Referring again to FIG. 1, operational environment 100 includes a brief example of process 200 as employed by elements of operational environment 100 in an implementation. In operational environment 100, a user submits user query 101 to computing device 110 for information to be derived from SAR data, such as from one or more of SAR data 141, 143, and 145. User query 101 may be a natural language query which the user keys into an interface executing on computing device 110 or speaks into an audio input device of computing device 110 which is then transcribed to text. Prompt engine 121 of processing platform 120 receives natural language query 101 from computing device 110 and generates a prompt for LLM service 150 which tasks LLM service 150 with generating instructions from implementation by a SAR processor to accomplish a task specified in user query 101 or to answer a question posed in user query 101. In an implementation, the prompt instructs LLM service 150 with generating instructions for SAR data which has been standardized for handling by processor 123.

In response to the prompt, LLM service 150 generates SAR data processing instructions by which SAR data 141, 143, and/or 145 is/are to be processed. LLM service 150 transmits the instructions to processor engine 123. A natural language processor of processor 123 parses the instructions to extract information for configuring one or more algorithm to process the SAR data specified in the instructions. Processing SAR data can include combinations of SAR data transformation functions and processes, such as image formation, ortho-rectification, interferometry, SAR tomography, change detection, subaperture processing, automatic target recognition, moving target indicator, and the like. Processor 123 maintains a library of modules and primitives for configuring the algorithm so that the processor can accommodate SAR data processing regardless of the SAR data type or source. Processor 123 configures the processor according to the instructions using modules and primitives identified in the instructions.

Processor 123 receives one or more of SAR data 141, 143, and 145 according to the instructions for processing by the configured processing algorithm. In an implementation, a pre-processor module (not shown) of processing platform 120 standardizes SAR data 141, 143, and 145 for input into the processing algorithms. In some implementations, processor 123 may post-process the output of the algorithms to generate information response to user query 101, such as cropped images, distance measurements, location coordinates, etc. Processor 123 generates an answer to user query 101 based on the output of the processing or post-processing steps and sends the answer to computing device 110 for export, download, display, etc.

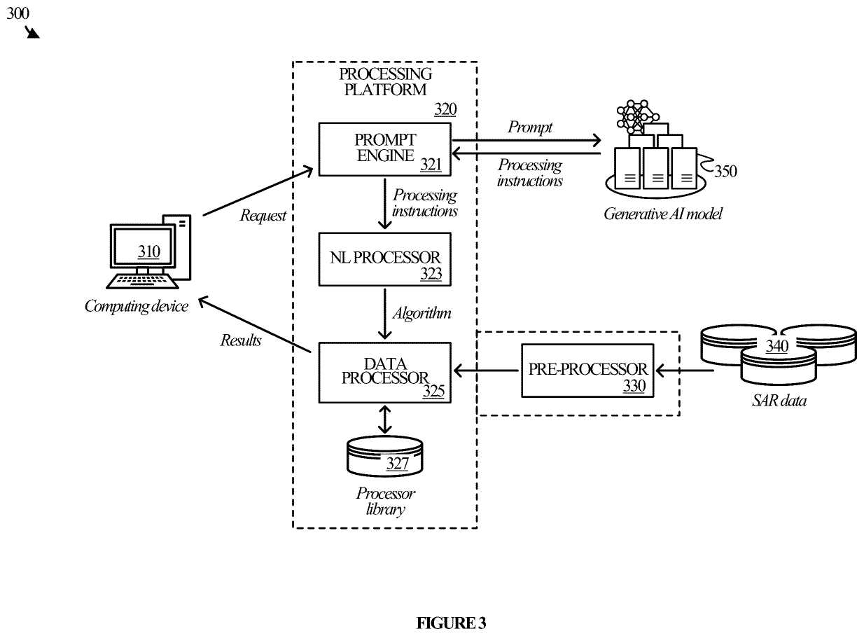

FIG. 3 illustrates an operating environment for SAR data processing in an implementation. Operational environment 300 of FIG. 3 includes computing device 310, processing platform 320 which includes prompt engine 321, natural language processor 323, data processor 325, and processor library 327, pre-processor 330, SAR data 340, and generative AI model 350. Although pre-processor 330 is shown apart from processing platform 320, it may be appreciated that in some implementations, pre-processor 330 is an element or module of processing platform 320. Prompt engine 321, natural language processor 323, data processor 325, pre-processor 330 together with other elements (not shown) of processing platform 320 may perform process 200 of FIG. 2 to process SAR data 340 in response to a request from computing device 310.

Computing device 310 is representative of a computing device capable of communicating with prompt engine 321 and data processor 325 over a communication network. Examples of computing device 310 include a computer, tablet, laptop, smart phone, or the like. Communication between computing device 310 and such engines may occur over the communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

Processing platform 320 is representative of one or more computing services capable of interfacing with computing device 310. Processing platform 320 includes one more engines, models, services, or computing architectures such as prompt engine 321, natural language processor 323, data processor 325, processor library 327. Processing platform 320 may be implemented in software in the context of one or more server computers co-located or distributed across one or more data centers. Examples of such servers include web servers, application servers, virtual or physical servers, or any combination or variation thereof, of which computing device 501 in FIG. 5 is broadly representative. Processing platform 320 may communicate with computing device 110 via one or more internets, intranets, the Internet, wired and wireless networks, LANs, WANs, and any other type of network or combination thereof.

Prompt engine 321 of processing platform 320 is representative of a system configured to receive a request from computing device 310 and generate a prompt based on a request for generative AI model 350.

Natural language processor 322 is representative of a processing system configured to parse processing instructions or other text from generative AI model 350 and generate an algorithm by which data processor 327 processes data from SAR data 340.

Data processor 327 is representative of a processing system including one or more CPUs or GPUs configured to perform processing operations on data from SAR data 340. Data processor 327 is operatively or communicatively coupled to processor library 327 to receive processing functionality, such as modules and primitives for SAR processing, for generating processing algorithms based on processing instructions received from natural language process 323. Processor library 327 includes processing functionality which enables data processor 327 to be sensor-agnostic, that is to say, to generate algorithms regardless of the source of SAR data 340.

Pre-processor 330 is representative of a processing system for processing SAR data 340 for subsequent input to an algorithm executed by data processor 325. Pre-processor 330 receives datasets of SAR data 340 and standardizes the data by stripping off metadata and other extraneous information and reformatting the data files into a common data file. The operations performed by pre-processor 330 may be performed prior to processing platform 320 receiving a request from computing device 310 and stored in the standardized format for subsequent input to data processor 325.

Generative AI model 370 is representative of a generative AI service or platform trained or fine-tuned for generating instructions for processing SAR data based on natural language queries such as the request received by prompt engine 321 from computing device 310. Generative AI model 370 may be implemented in the context of one or more server computers co-located or distributed across one or more data centers. Generative AI model 370 hosts a deep learning AI model, such as GPT-3®, GPT-3.5, ChatGPT®, or GPT-4, BERT, ERNIE, T5, XLNet, or other foundation model. Generative AI model 370 interfaces with prompt engine 321 to receive prompts based on a request from computing device 310 and to return replies including SAR data processing instructions or algorithms to prompt engine 321.

In a brief operational example of the elements of operational environment 300 for processing data from SAR data 340, computing device 310 displays a user interface hosted by processing platform 320 by which a user can create and submit requests for information to be extracted or identified from SAR data 340. (In the discussion below, SAR data 340 will refer to SAR data that has been standardized by pre-processor 330.) For example, a user may submit a request to prompt engine 321 in natural language in the form of a question or a command and may be keyed into a chat pane, transcribed to text from captured audio, or other manner.

Prompt engine 321 configures a prompt based on the request according to a prompt template. The prompt template includes a default set of rules and instructions for generative AI model 350, such as instructions or rules to select data or datasets for processing from among SAR data 340 and to output the processing instructions according to the given formatting rules or instructions. The prompt template may include information about the processing functionality of processor library 327 for processing data from SAR data 340. The prompt template may include the request and examples of the type of output that prompt engine 321 expects to receive. With the prompt configured, prompt engine 321 submits the prompt to generative AI model 350.

Generative AI model 350 creates processing instructions based on the prompt according to its training or fine-tuning. To do so, generative AI model 350 has been previously trained or fine-tuned to generate one or more custom algorithms suitable to respond to a query from computing device 310. Generative AI model 350 may have been trained or fine-tuned using natural language queries paired with existing SAR-data processing algorithms which process SAR data in such a way that the resulting output can be used to extract information responsive to the associated query. Generative AI model 350 may also be trained on labeled data, questions, feature requests, and existing known problems related to SAR data processing currently being solved or investigated for intelligence or military purposes. Subsequent to generating output in response to the prompt, generative AI model 350 returns output including the processing instructions based on the prompt to prompt engine 321. Prompt engine 321 extracts the processing instructions from the output and sends the processing instructions to natural language processor 323.

Upon receiving the processing instructions from prompt engine 321, natural language processor 323 generates an algorithm for processing SAR data. (It may be appreciated that the algorithm configured by natural language processor 330 is representative of a class or suite of one or more SAR data processing algorithms which are coded according to the processing instructions generated by generative AI model 370.) Natural language processor 323 transmits the configured algorithm to data processor 325 for execution.

Upon receiving the algorithm, data processor 325 executes the algorithm on data received from SAR data 340. To execute the algorithm, data processor 325 may receive processing functionality from processor library 327 according to the algorithm. Results generated from the execution of the algorithm may be further post-processing to extract and format information responsive to the request.

In a brief example of the interaction between the elements of processing platform 320, the request may include a request for change detection on SAR data related to a ground-based target captured by satellite or airborne imaging sensors. Based on the request, the processing instructions may specify a change detection function from processor library 327 specific to the source of the selected SAR data for the processing algorithm. Data processor 325 then obtains the selected data from SAR data 340 and the change detection function from processor library 327 and executes the algorithm to produce results including changes with respect to the target per the request. The output from the execution is processed for transmission to computing device 310 where the user can view or perform other tasks on the results.

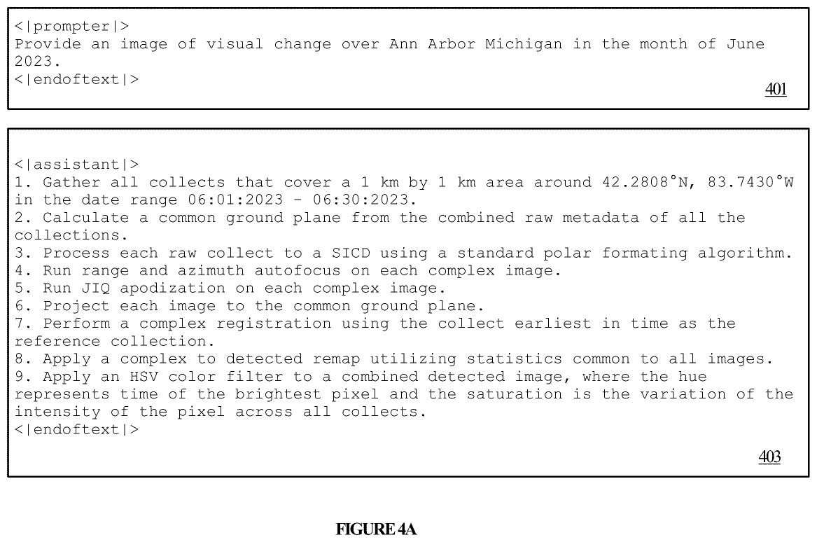

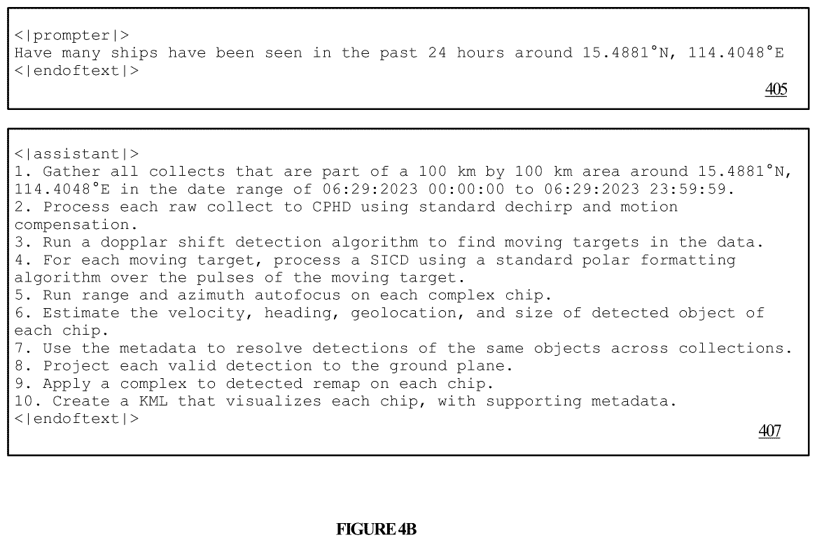

FIGS. 4A and 4B illustrate prompts to a generative AI model and replies received from the generative AI model for generating SAR data processing algorithms in an implementation. In an exemplary implementation, a SAR data processing platform hosts a system for processing SAR data based on a user query, where the processing platform tasks a generative AI engine, such as an LLM, to generate processing instructions. The generative AI engine has been trained to generate processing instructions for processing SAR data according to natural language queries. The processing platform identifies one or more processing operations for each of the steps of the processing instructions and encodes an algorithm for processing SAR data which includes the processing operations in a sequence indicated by the program instructions. The processing operations may be selected from a processor library which includes processing operations according to the type or source of SAR data to be processed. A data processor of the processing platform then executes the algorithm to process the SAR data, producing results response to the user's query.

In FIG. 4A, prompt 401 is configured based on a user query received from a computing device in communication with the processing platform. The user query included in prompt 401 requests an image which shows a visual change to a particular location (Ann Arbor) at a specified time (June 2023).

Output 403 is generated by a generative AI engine in response to prompt 401. Output 403 includes a numbered sequence of steps to generate the requested image, including (in Step 1) selected SAR data (“all collects that cover . . . ”), GPS coordinates of the location of interest, and the date range of interest. Steps 2-9 specify data processing operation. A natural language processor receiving the processing instructions of output 403 parses the instructions and encodes an algorithm which performs each of the steps in the indicated sequence. A data processor receives and executes the algorithm on the specified data. To execute the algorithm, the data processor may draw processing functionalities from a processor library operatively coupled to the data processor. The results of the execution are processed from transmission to the user computing device.

In FIG. 4B, prompt 405 is configured based on a user query which requests a count of objects (ships) detected during a given timeframe at a particular location. In response, the generative AI model produces output 407 which includes a sequence of ten steps for processing SAR data, including (in Step 1) selected SAR data (“all collects that are part of a 100 km by 100 km area around . . . ”), GPS coordinates of the location of interest, and the date range of interest. A natural language processor receiving the processing instructions of output 407 parses the instructions and encodes an algorithm which performs each of the steps in the indicated sequence. A data processor receives and executes the algorithm on the specified data. To execute the algorithm, the data processor may draw processing functionalities from a processor library operatively coupled to the data processor. The results of the execution are processed from transmission to the user computing device.

FIG. 5 illustrates computing device 501 that is representative of any system or collection of systems in which the various processes, programs, services, and scenarios disclosed herein may be implemented. Examples of computing device 501 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 501 may be implemented as a single apparatus, system, or device or may be implemented in a distributed manner as multiple apparatuses, systems, or devices. Computing device 501 includes, but is not limited to, processing system 502, storage system 503, software 505, communication interface system 507, and user interface system 509 (optional). Processing system 502 is operatively coupled with storage system 503, communication interface system 507, and user interface system 509.

Processing system 502 loads and executes software 505 from storage system 503. Software 505 includes and implements SAR data process 506, which is (are) representative of the SAR data algorithm generation and execution processes discussed with respect to the preceding Figures, such as process 200. When executed by processing system 502, software 505 directs processing system 502 to operate as described herein for at least the various processes, operational scenarios, and sequences discussed in the foregoing implementations. Computing device 501 may optionally include additional devices, features, or functionality not discussed for purposes of brevity.

Referring still to FIG. 5, processing system 502 may comprise a micro-processor and other circuitry that retrieves and executes software 505 from storage system 503. Processing system 502 may be implemented within a single processing device but may also be distributed across multiple processing devices or sub-systems that cooperate in executing program instructions. Examples of processing system 502 include general purpose central processing units, graphical processing units, application specific processors, and logic devices, as well as any other type of processing device, combinations, or variations thereof.

Storage system 503 may comprise any computer readable storage media readable by processing system 502 and capable of storing software 505. Storage system 503 may include volatile and non-volatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 503 may also include computer readable communication media over which at least some of software 505 may be communicated internally or externally. Storage system 503 may be implemented as a single storage device but may also be implemented across multiple storage devices or sub-systems co-located or distributed relative to each other. Storage system 503 may comprise additional elements, such as a controller, capable of communicating with processing system 502 or possibly other systems.

Software 505 (including SAR data process 506) may be implemented in program instructions and among other functions may, when executed by processing system 502, direct processing system 502 to operate as described with respect to the various operational scenarios, sequences, and processes illustrated herein. For example, software 505 may include program instructions for implementing a SAR data process, including SAR data algorithm generation and execution as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 505 may include additional processes, programs, or components, such as operating system software, virtualization software, or other application software. Software 505 may also comprise firmware or some other form of machine-readable processing instructions executable by processing system 502.

In general, software 505 may, when loaded into processing system 502 and executed, transform a suitable apparatus, system, or device (of which computing device 501 is representative) overall from a general-purpose computing system into a special-purpose computing system customized to support SAR data processes in an optimized manner. Indeed, encoding software 505 on storage system 503 may transform the physical structure of storage system 503. The specific transformation of the physical structure may depend on various factors in different implementations of this description. Examples of such factors may include, but are not limited to, the technology used to implement the storage media of storage system 503 and whether the computer-storage media are characterized as primary or secondary storage, as well as other factors.

For example, if the computer readable storage media are implemented as semiconductor-based memory, software 505 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 507 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 501 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer-readable storage media;
one or more processors operatively coupled to the one or more computer-readable storage media; and
program instructions stored on the one or more computer-readable storage media that, when executed by the one or more processors, direct the computing apparatus to:
receive a request for information based on synthetic aperture radar (SAR) data;
generate a prompt for a large language model (LLM) based on the request, wherein the prompt includes a request for processing instructions for processing the SAR data;
generate a processing algorithm based on the processing instructions; and
process the SAR data according to the processing algorithm.

2. The computing apparatus of claim 1, wherein to generate a processing algorithm based on the processing instructions, the program instructions direct the computing apparatus to identify processing operations for performing steps of the processing instructions and to encode the processing operations for the processing algorithm.

3. The computing apparatus of claim 2, wherein to encode the processing operations for the processing algorithm comprises configuring a series of SAR modules and primitives by which to process the SAR data.

4. The computing apparatus of claim 3, wherein the program instructions further direct the computing apparatus to pre-process the SAR data to standardize a format of the SAR data.

5. The computing apparatus of claim 4, wherein to process the SAR data, the program instructions direct the computing apparatus to receive the processing operations from a processor library.

6. The computing apparatus of claim 5, wherein the program instructions further direct the computing apparatus to select the SAR data for processing based on the processing instructions.

7. The computing apparatus of claim 1, wherein the LLM is trained based on datasets including SAR data processing algorithms and natural language queries corresponding to the SAR data processing algorithms.

8. The computing apparatus of claim 7, wherein to receive the request, the program instructions further direct the computing apparatus to display a user interface on a computing device, to receive the request from computing device via the user interface, and to display, in the user interface, information based on processing the SAR data according to the processing algorithm.

9. A method of operating a data processing platform comprising:
receiving a request for information based on synthetic aperture radar (SAR) data;
generating a prompt for a large language model (LLM) based on the request, wherein the prompt includes a request for processing instructions for processing the SAR data;
generating a processing algorithm based on the processing instructions; and
processing the SAR data according to the processing algorithm.

10. The method of claim 9, wherein generating the processing algorithm based on the processing instructions comprises identifying processing operations for performing steps of the processing instructions and encoding the processing operations for the processing algorithm.

11. The method of claim 10, wherein encoding the processing operations for the processing algorithm comprises configuring a series of SAR modules and primitives by which to process the SAR data.

12. The method of claim 11, further comprising pre-processing the SAR data to standardize a format of the SAR data.

13. The method of claim 12, wherein processing the SAR data comprises executing the processing operations from a processor library.

14. The method of claim 13, further comprising selecting SAR data for processing based on the processing instructions.

15. The method of claim 9, wherein the LLM is trained based on datasets including SAR data processing algorithms and natural language queries corresponding to the SAR data processing algorithms.

16. The method of claim 15, wherein receiving the request for information based on the SAR data comprises displaying a user interface on a computing device, receiving the request from the computing device via the user interface, and displaying, in the user interface, information based on processing the SAR data according to the processing algorithm.

17. A method of operating processing platform, the processing platform comprising:
a prompt engine;
a natural language processing engine; and
a data processing engine;
the method comprising:
by the prompt engine:
receiving a request for information based on synthetic aperture radar (SAR) data;
generating a prompt for a generative artificial intelligence (AI) model based on the request, wherein the prompt includes a request for instructions for processing the SAR data; and
responsive to submitting the prompt to the generative AI model, receiving the processing instructions from the generative AI model based on the prompt, wherein the processing instructions comprise a sequence of steps for processing the SAR data;
by the natural language processing engine:
identifying processing operations, wherein a processing operation of the processing operations is identified for each step of the sequence of steps; and
encoding a processing algorithm including the processing operations from the generative AI model; and
by the data processing engine:
executing the processing algorithm to process the SAR data to determine a response to the request.

18. The method of claim 17, wherein the processing platform further comprises a pre-processor, and wherein the method further comprises, by the pre-processor, standardizing the SAR data to a common data format.

19. The method of claim 18, wherein the generative AI model comprises a large language model, wherein the large language model is trained based on datasets including SAR data processing algorithms and natural language queries corresponding to the SAR data processing algorithms.

20. The method of claim 19, wherein the request for instructions for processing the SAR data comprises a request for a sequence of one or more processing operations for processing the SAR data.
